(19) United States
(12) Patent Application Publication
(10) Pub. No.: US 2026/0214161 A1
(43) Pub. Date: Jul. 23, 2026

(54) IDENTIFICATION OF CUSTOMER CALL QUALITY ISSUES WITHIN A 5G RADIO ACCESS NETWORK

(71) Applicant: Boost SubscriberCo. L.L.C., Englewood, CO (US)

(72) Inventors: Ehab Sameh Naguib Abdo, Highlands Ranch, CO (US); Tamanna Kawatra, Highlands Ranch, CO (US); Tarek Nasreldeen R. Halawa, Centennial, CO (US); Arnold Foronda Agcaoili, Littleton, CO (US)

(21) Appl. No.: 19/033,802

(22) Filed: Jan. 22, 2025

(51) Int. Cl. H04M 3/22; H04W 4/16

(52) U.S. Cl. CPC H04M 3/2227; H04W 4/16

(57) ABSTRACT

A method includes receiving information indicative of termination of a first voice call over a wireless network, the termination being initiated by one of multiple participants of the first voice call, obtaining time series data indicative of one or more metrics over a first time period preceding a time point at which the termination of the first voice call is initiated, the one or more metrics indicative of call quality of the first voice call, determining, based on the time series data, that the termination of the first voice call is attributable to a call quality issue, and responsive to determining that the termination of the first voice call is attributable to a call-quality issue, generating one or more signals configured to initiate a remedial measure to address the call quality issue.

### TECHNICAL FIELD

The present disclosure relates to a wireless communication system, and more particularly, relates to technology for identification of customer call quality issues within a radio access network (RAN).

### BACKGROUND

A wireless network provides voice and data services to a user equipment (UE) in geographical areas covered by the network. For example, the UE can transmit and receive data in the covered areas using a base station (BS) of the network or a partner network within the covered areas.

### SUMMARY

In some aspects, the subject matter described in this specification is embodied in methods that include the actions of receiving, at one or more processing devices, information indicative of termination of a first voice call over a wireless network, the termination being initiated by one of multiple participants of the first voice call, obtaining, by the one or more processing devices, time series data indicative of one or more metrics over a first time period preceding a time point at which the termination of the first voice call is initiated, the one or more metrics indicative of call quality of the first voice call, determining, based on the time series data, that the termination of the first voice call is attributable to a call quality issue, and responsive to determining that the termination of the first voice call is attributable to a call-quality issue, generating one or more signals configured to initiate a remedial measure to address the call quality issue.

In some implementations, the actions may include determining that the termination of the first voice call is attributable to a call quality issue by obtaining, by the one or more processing devices, information indicative of an attempt by one of the multiple participants to initiate a second voice call with another of the multiple participants, and determining that the time series data indicates a degradation of the call quality during the first time period.

In some implementations, the actions may include determining that the termination of the first voice call is attributable to a call-quality issue by providing the time series data to a machine learning model trained to identify a cause for call termination based on the one or more metrics, and determining, based on an output of the machine learning model, that the termination of the first voice call is attributable to a call quality issue.

In some implementations, the one or more metrics indicative of call quality of the first voice call includes information indicative of an audio gap detected during the first voice call exceeding a threshold period of time.

In some implementations, the one or more metrics indicative of call quality of the first voice call includes information indicative of a quantified quality score being less than a threshold value during the first voice call.

In some implementations, the one or more metrics indicative of call quality of the first voice call includes information indicative of a packet loss rate and a jitter value.

In some implementations, the one or more metrics indicative of call quality of the first voice call includes information indicative of at least one of: a signal-to-interference-plus-noise ratio (SINR) or a reference signal received power (RSRP).

In some implementations, the one or more metrics indicative of call quality of the first voice call includes information indicative of at least one of a block error rate (BLER) or a bit error rate (BER).

In some implementations, generating the one or more signals configured to initiate the remedial measure to address the call-quality issue includes generating a signal to instruct a user device identified as experiencing a call quality issue to switch to an available roaming network.

In some implementations, generating the one or more signals configured to initiate the remedial measure to address the call-quality issue includes generating a signal to instruct one or more user equipment to accelerate idle mode resection.

In some implementations, generating the one or more signals configured to initiate the remedial measure to address the call-quality issue includes generating a signal to offload user equipment that have a signal quality below a threshold quality value.

In another general aspect, a system is provided. The system includes one or more computers and one or more storage devices on which are stored instructions that are operable when executed by the one or more computers, to cause the one or more computers to perform operations including receiving, at one or more processing devices, information indicative of termination of a first voice call over a wireless network, the termination being initiated by one of multiple participants of the first voice call, obtaining, by the one or more processing devices, time series data indicative of one or more metrics over a first time period preceding a time point at which the termination of the first voice call is initiated, the one or more metrics indicative of call quality of the first voice call, determining, based on the time series data, that the termination of the first voice call is attributable to a call quality issue, and responsive to determining that the termination of the first voice call is attributable to a call-quality issue, generating one or more signals configured to initiate a remedial measure to address the call quality issue.

Implementations of the system can include one or more of the following features. In some implementations, the actions may include determining that the termination of the first voice call is attributable to a call quality issue by obtaining, by the one or more processing devices, information indicative of an attempt by one of the multiple participants to initiate a second voice call with another of the multiple participants, and determining that the time series data indicates a degradation of the call quality during the first time period.

In some implementations, the actions may include determining that the termination of the first voice call is attributable to a call-quality issue by providing the time series data to a machine learning model trained to identify a cause for call termination based on the one or more metrics, and determining, based on an output of the machine learning model, that the termination of the first voice call is attributable to a call quality issue.

In some implementations, the one or more metrics indicative of call quality of the first voice call includes information indicative of an audio gap detected during the first voice call exceeding a threshold period of time.

In some implementations, the one or more metrics indicative of call quality of the first voice call includes information indicative of a quantified quality score being less than a threshold value during the first voice call.

In some implementations, the one or more metrics indicative of call quality of the first voice call includes information indicative of a packet loss rate and a jitter value.

In some implementations, the one or more metrics indicative of call quality of the first voice call comprises information indicative of at least one of a signal-to-interference-plus-noise ratio (SINR) or a reference signal received power (RSRP).

In some implementations, the one or more metrics indicative of call quality of the first voice call includes information indicative of at least one of: a block error rate (BLER) or a bit error rate (BER).

In another general aspect, a non-transitory computer readable medium is provided. The non-transitory computer readable medium stores instructions that are executable by a processing device, and upon such execution cause the processing device to perform operations. The operations include receiving, at one or more processing devices, information indicative of termination of a first voice call over a wireless network, the termination being initiated by one of multiple participants of the first voice call, obtaining, by the one or more processing devices, time series data indicative of one or more metrics over a first time period preceding a time point at which the termination of the first voice call is initiated, the one or more metrics indicative of call quality of the first voice call, determining, based on the time series data, that the termination of the first voice call is attributable to a call quality issue, and responsive to determining that the termination of the first voice call is attributable to a call-quality issue, generating one or more signals configured to initiate a remedial measure to address the call quality issue.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1A is a schematic diagram of two users communicating over a radio access network (RAN).

FIG. 1B is an example of a RAN intelligent controller (RIC).

FIG. 2 is a flowchart of a process for generating one or more signals configured to initiate a remedial measure to address the call-quality issue.

FIG. 3 is a diagram illustrating examples of a computing device usable for implementing at least portions of technology described herein.

Like reference numbers and designations in the various drawings indicate like elements.

### DETAILED DESCRIPTION

At times, customers using a wireless cellular network may experience call quality issues. A service provider can easily identify customers that are experiencing poor call quality when a voice call is dropped, that is, when the call is not affirmatively terminated by a user, but rather disconnects due to other issues such as poor network connectivity. However, in some instances, a customer that is experiencing poor call quality may decide to voluntarily terminate the call, for example, using an end call button of the user device. When a customer voluntarily terminates a call using the end call button, the service provider typically does not classify the call as a failed call. Consequently, the service provider may be unable to readily detect that the customer is encountering call quality issues. Customers who frequently experience call quality issues and other network performance problems may choose to unsubscribe from the service provider. The churn rate, defined as the rate at which customers unsubscribe from a service provider, tends to be higher when customers endure unresolved network issues, including poor call quality, over an extended period.

The technology described herein facilitates evaluating whether a voluntarily terminated call is attributable to any network, quality, or service issues. For example, the technology described herein supports a process in which various metrics associated with the quality of a voice call are monitored during a time period leading up to the call being voluntarily terminated by a customer. The process further involves making a determination, based on the various metrics, that a voice call quality issue is in fact the cause for termination of the call by the customer, and in some cases, providing remedial measures to address the identified call quality issue. In some implementations, this can allow for fast and efficient identification and resolution of call quality issues thereby providing for high-quality network administration. This in turn may lead to satisfactory customer experiences, and potentially a decreased churn rate.

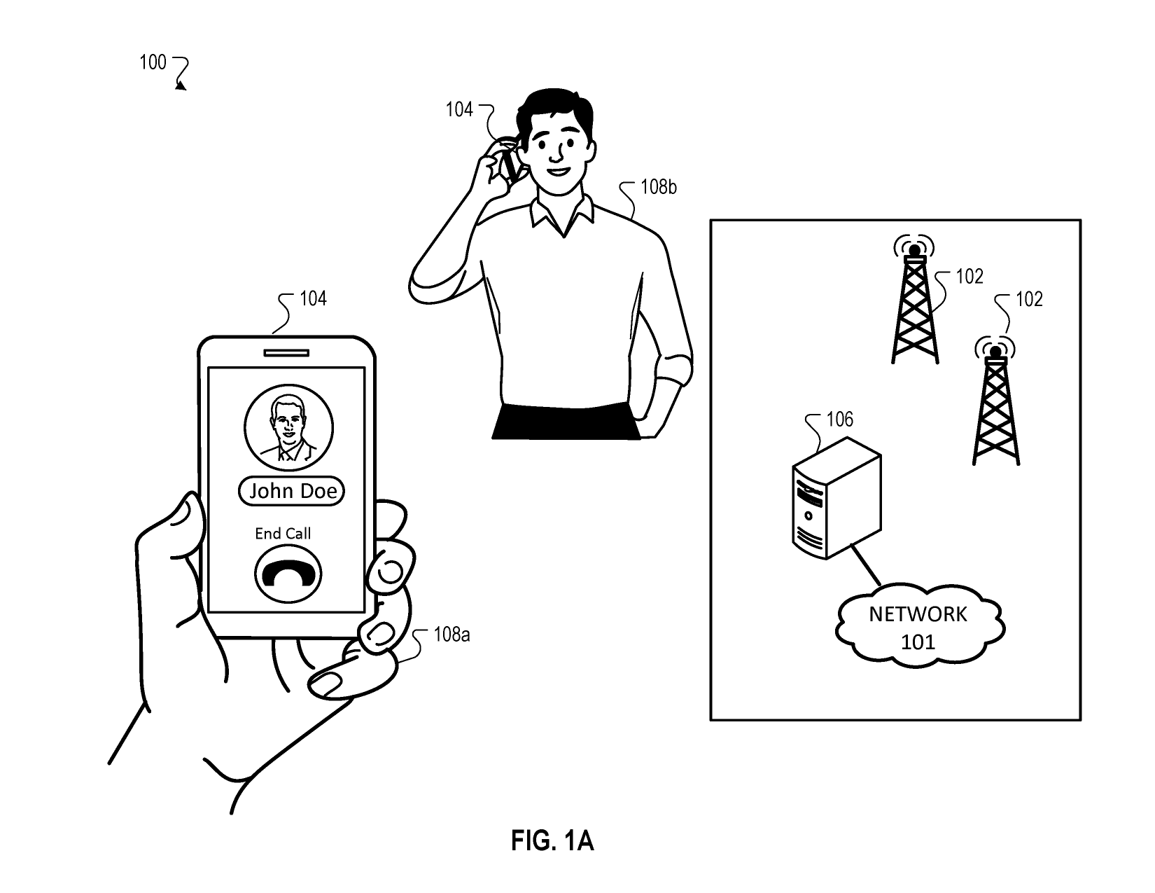

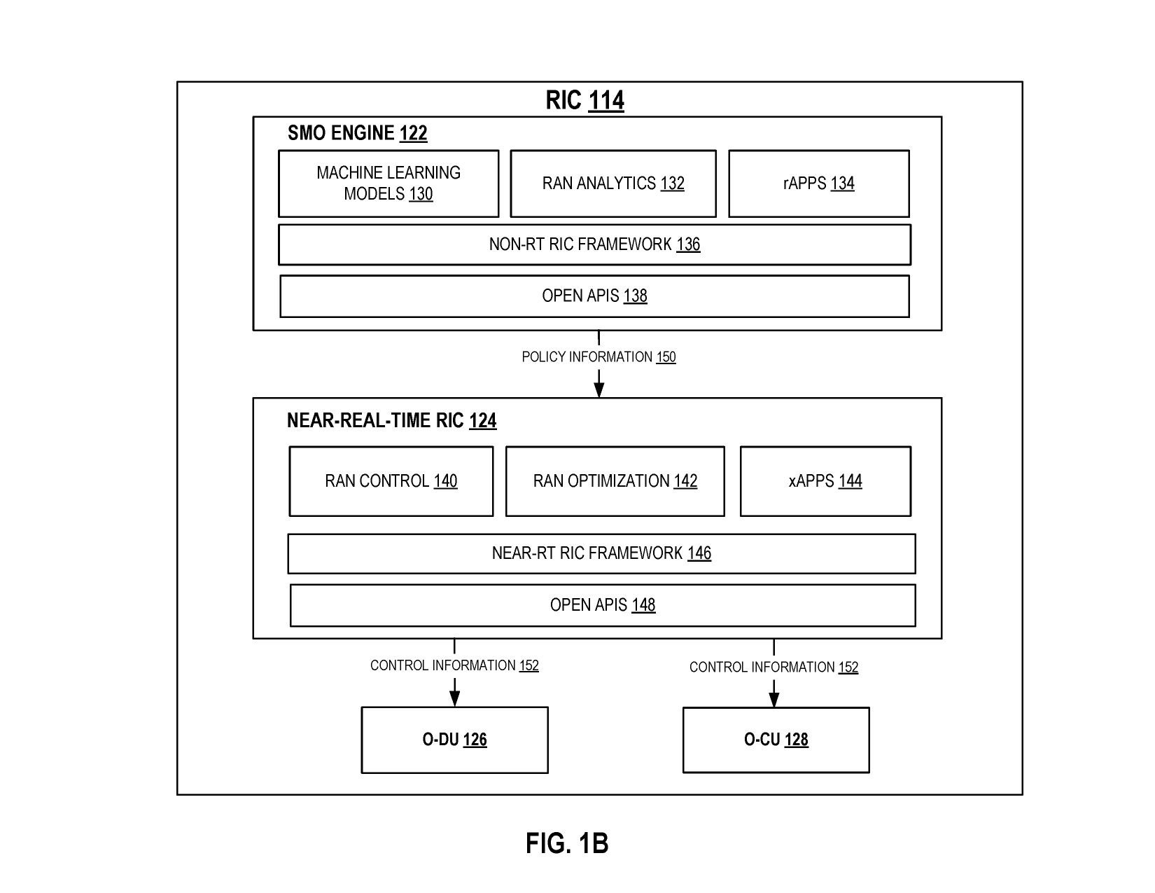

FIG. 1A is a schematic diagram 100 of two users communicating over a radio access network 101. The RAN 101 may include one or more base stations 102, one or more user equipment (UE) 104, and a cloud system 106. The cloud system 106 may be a portion of a distributed computing system that executes one or more applications supporting the operations of the RAN 101. In some implementations, the RAN 101 may be an O-RAN, for example, a 5G O-RAN. The RAN 101 may be managed by a service provider that services the one or more UEs 104 . One or more different components within the network 101 may be configured to monitor voice calls and/or video calls, and associated data/metrics indicative of call quality. For example, the one or more base stations 102 may monitor the voice calls and or video calls made by the one or more UEs 104 supported by the network 101 to track data/metrics indicative of call quality. These data/metrics can be used, for example, to determine the reasons behind a call being disconnected. As described herein, the data/metrics can be used to determine whether a user-disconnected call was terminated because the user experienced network/connectivity issues that forced the termination. In some implementations, the monitoring may be substantially continuous. For example, the one or more different components within the network 101 may monitor voice calls and/ or video calls every 10 milliseconds, or every 20 milliseconds.

As illustrated in FIG. 1A, a user 108a may be participating in a voice call with a second user 108b, users 108 in general. At least one of the participants of the call may experience call quality issues during the call. The user 108a may decide to terminate the call with the second user 108b by pressing the end call button on their UE 104. When the user 108a terminates the call, at least one component within the network 101 receives a termination signal from the UE 104. For example, a base station 102 within the network 101 may receive a termination signal from the UE 104 and confirm that the call was terminated based on receiving the termination signal.

Based on the base station 102 receiving a termination signal, at least one component within the network 101 accesses time series data which is indicative of one or more call quality metrics associated with the terminated call. For example, the base station 102 may access time series data that is representative of the call quality metrics during a time period preceding the end point of the terminated call. For example, the base station 102 may access data for a predetermined duration (e.g., the last ten seconds of the call) preceding the voluntarily termination of the call. In some implementations, one or more other components of the network 101 can track call quality metrics during a time period preceding the end point of a terminated call. For example, an application running on the cloud may be configured to access time series data that is representative of the call quality metrics.

In some implementations, the time period may be dynamically determined, for example, based on the total length of the call. For example, the time period can be a percentage (e.g., 5% or 10%) of the total length of the call. In some implementations, the time period may be dynamically determined based on the total length of the call and one or more other network related factors. In some implementations, the time-period may be determined based on a periodic study of historically impacted users of the network.

The time series data/metrics indicative of call quality can be of various types. For example, the time series data may include data indicative of a Mean Opinion Score (MOS) which evaluates a quality of the audio call. A MOS is the measure of the quality of audio or video services, and is based on subjective evaluations from multiple users to provide a single value that reflects the overall quality perceived by users. The time series data may be indicative of one or more different types of data that each individually or collectively assess the quality of a call. The time series data may be a sequence of data points that are recorded over a period of time, and may be collected at specific time intervals during the duration of the call. The time series data may include one or more of the following types of data: mean opinion score data, audio gap data, packet loss rate data, Real-time Transport Protocol (RTP) jitter value data, signal-to-interference-plus-noise ratio (SINR) data, a reference signal received power (RSRP) data, transmission control protocol (TCP) transmission rate data, block error rate (BLER) data, bit error rate (BER) data, and/ or uplink received signal strength indicator (RSSI) data.

In some implementations, the one or more metrics of the time series data may include data that is indicative of an audio gap being detected during the call, where the audio gap exceeds a threshold period of time. In some implementations, the one or more metrics of the time series data may include data that is indicative of a quantified quality score being less than a threshold value. For example, the time series data may include data that is indicative of a Mean Opinion Score (MOS) which evaluates a quality of the audio call. In some implementations, the time series data may include data that is indicative of a packet loss rate for the call, the packet loss rate representing a measure of a percentage of data packets that fail to be transmitted over the network. For example, the time series data may indicate a packet loss rate being over above 1% indicating that the call quality is low.

The time series data may include a RTP jitter value of the call, the jitter value representing the inconsistency of the rate of transmission of packets within the network. In some implementations, the time series data may include data that is indicative of a signal-to-interference-plus-noise ratio (SINR). The SINR representing a comparison of the power of a desired signal to the power of the interference and background noise in combination. In some implementations, the time series data may include data that is indicative of a reference signal received power (RSRP), the RSRP value representing an average power level of a signal received by a UE 104 from a base station 102. In some implementations, the time series data may include data that is indicative of a transmission control protocol (TCP) transmission rate of the call. The TCP transmission rate represents, in bits per second, a speed of data transmission speed over a TC connection.

In some implementations, the time series data may include data that is indicative of a block error rate (BLER), the BLER representing a measure of the reliability of the transmission of data over the network and being calculated as a fraction of a number of erroneous blocks to the total number of blocks sent. In other implementations, the time series data may include data that is indicative of a bit error rate (BER), which represents the rate of errors in data transmission based on the number of erroneous bits over the total number of bits sent. In some other implementations, the time series data may include data that is indicative of an uplink received signal strength indicator (RSSI), the RSSI being a quantifiable measure of the power level of a received signal. In some implementations, the time series data may include each of the types of data identified above. In other implementations, the time series data may include at least a subset of the types of data identified above. In yet another implementation, the time series data may include one or more other types of data, and each of the one or more additional types of data being representative of a measure of the quality of an audio call or a video call in a RAN.

The time series data indicative of call quality can be analyzed to determine whether the termination of the call by the user 108a was attributable to call quality. In some implementations, an application executing on a cloud deployed system, such as an O-RAN, can analyze the time series data. For example, the cloud system 106 of the network 101 may analyze the time series data indicative of the call quality, to determine whether the termination of the call by the user 108a was attributable to the call quality. In some implementations the cloud system 106 uses the time series data and/or information indicating whether a participant of the call, either user 108a or user 108b, initiated a subsequent call with the same participants within a threshold period of time (e.g., 5 seconds, 10 seconds, 15 seconds, etc.) to determine whether the first call was terminated based on the call quality issues. For example, when either participant 108a or 108b of an initial call reinitiates a subsequent call to the other participant within the threshold period after termination of the initial call, a determination could be made that the initial call was terminated because of call quality issues.

In some implementations, degradation of call quality can be determined/corroborated using the time series data leading up to the termination of the call indicating that the call quality indeed degraded leading up to the termination of the call. In some implementations, the cloud system 106 may implement a machine learning model to identify when the termination of a call was due to call quality issues. In these implementations, the cloud system 106 may continuously receive time series data that is indicative of one or more call quality metrics from the one or more base stations 102 within the network 101. The cloud system 106 may use the received time series data to develop and train a machine learning model to identify when the termination of a call was due to a call quality issue. The machine learning model may be trained via a learning process using a large corpus of call quality metrics and network data. In some implementations, the machine learning model may be trained and retrained based on the cloud application periodically receiving updated time series data.

In some implementations, when a determination is made that the termination of the call is based in a call quality issues, a remedial measure to address the call quality issue may be initiated. In some implementations, the cloud system 106 may determine that the termination of the call is attributable to a call quality issue, and may initiate a remedial measure to address the call quality issue by relocating/adjusting the distribution of resources. For example, when the cloud system 106 determines that the call quality issue is due to resource utilization and congestion within the network 101, the cloud system 106 may communicate to one or more components within the network 101 to implement a configuration change to mitigate and/or prevent the detected call degradation.

In some implementations, the cloud system 106 may train a model to predict call quality degradation. In these implementations, the machine learning model may also be trained to implement a resource configuration that can be implemented to mitigate and or prevent the call degradation. In some implementations, the machine learning model may be configured to provide configuration changes. For example, the machine learning model may provide a configuration which directs users within a particular geographic location to connect to a cell tower that is less loaded than anther cell tower that is more loaded (and associated with the call degradation issues).

In some implementations, when the machine learning model determines that the call quality issues are related to signal level or signal quality issues, the cloud system 106 may increase the rate of idle mode reselection of the one or more UEs 104 that are experiencing signal level or signal quality issues. During the reselection processes, UEs 104 that are not currently being used by a user 108, that is, devices which are in idle mode, may periodically scan to locate base stations 102 in their vicinity, the UEs 104 measure the signal strength and quality of the base stations 102 in their vicinity. When a base stations 102 in the vicinity of UE 104 meets one or more performance criteria thresholds, such as, higher signal strength and/or better signal quality, the UE 104 may automatically request to connect to the base stations 102 without experiencing a drop in signal connection.

In some implementations, the cloud system 106 may instruct an increase in the idle mode reselection for a subset of UEs 104 within the network 101. In other implementations, cloud system 106 may instruct an increase in the idle mode reselection for UEs 104 based on the geographic location of the UE 104. For example, when the machine learning module determines that a UE 104 in a particular location is experiencing call quality issues related to signal level or signal quality, cloud system 106 may instruct the one or more UEs 104 in the particular location to increase the rate of idle mode reselection.

In some implementations, when the machine learning module determines that the time of day impacts the call quality issues, the cloud system 106 may accelerate the idle mode reselection of the UEs 104 experiencing issues. For example, when external factors such as weather conditions, interference, or power issues occur at a particular time of day, cloud system 106 may instruct the UEs 104 in the areas affected by the external factors to accelerate idle mode reselection. In some implementations, the cloud system 106 may instruct the connected mode mobility to focus on offloading UEs 104 with the highest usage of the impacted channel resource. In some implementations, the idle mode reselection mode parameter may utilize reselection and cell selection parameters, such as, RXlevmin, snonintrasearch, threshXhigh, thresxlow, qhyst, etc., and all connected mode mobility parameters including CIO, A2, A3, A5, A4, A5, B2, penalty timers, etc..

In some implementations, the machine learning module may be configured determine when a particular UE 104 is experiencing call quality issues. Based on the machine learning module determining a particular UE 104 is experiencing call quality issues, the cloud system 106 may accelerate the idle mode reselection and or the connected mode mobility to offload the impacted UE 104. For example, the impacted UE 104 may be offloaded to a second base station 102 in the vicinity.

In some implementations, when signal level or signal quality issues are detected, cloud system 106 may offload at least a subset of UEs 104 that are experiencing signal issues to another base station 102 within the network 101. In some implementations, when cloud system 106 determines that the call quality issue is due to the geographical location of the user 108, the cloud system 106 may reallocate/offload UEs 104 that have a reported poor signal level or quality to a second base station 102, which is in a close geographic proximity to the first base station 102, and that is not experiencing issue with signal levels or quality. As such, by monitoring data/metrics indicative of call quality, and using the tracked data/metrics for periods leading up to call terminations can help in identifying network issues that may otherwise remain undetected. By investigating terminations that are voluntary (rather than a result of a dropped call) various network issues may be detected and resolved proactively and efficiently. For example, even local issues that affect user experiences—but are not yet pervasive enough otherwise—can be detected and potentially resolved in initial stages – thereby leading to improved network health and resilience. This in turn can result in fewer outages, lower downtimes, and potentially improved user-experiences.

In some implementations, aspects of the technology described herein are implemented using a RIC in a 5G O-RAN. Specifically, because a RIC includes frameworks for both non-real-time and near-real-time processing, the RIC provides an ideal platform for implementing portions of the technology described herein. For example, the RIC facilitates the real-time or near real-time processing of time series data that is indicative of call quality.

FIG. 1B is a block diagram of an example RIC that executes O-RAN applications for a communication session of a 5G O-RAN network in accordance with technology described herein. The RIC 114 includes a Service Management and Orchestration (SMO) engine 122, a near real-time RIC 124, an O-RAN Distributed Unit (O-DU) 126, and an O-RAN Central Unit 128.

The RIC 114 is configured to perform non-real-time analysis and near-real-time analysis of traffic by executing performance applications in order to determine traffic quality. In particular, the RIC 114 is divided into non-real-time and near-real-time modules. The SMO engine 122 is configured to perform non-real-time analysis of traffic by executing machine learning models 130, RAN analytics 132, and/or rApps 134. The SMO engine 122 can execute the models 130, analytics 132, and rApps 134 using a non-real-time RIC framework 136 and one or more function calls (e.g., open APIs 138). The near real-time RIC 124 is configured to perform near real-time analysis of traffic during a communication session by executing RAN control 140, RAN optimization 142, or xApps 144. The SMO engine 122 can execute the RAN control 140, RAN optimization 142, and xApps 144 using a near-real-time RIC framework 146 and one or more function calls (e.g., open APIs 148). In some implementations, the xAPP 144 is configured to continuously receive time series data that is indicative of call quality metrics in real-time. The xAPP 144 may use the receive the time series data that is indicative of call quality metrics to develop and train a machine learning model to identify when the termination of a call was because of a call quality issue. The machine learning model may be trained via a learning process using a large corpus of call quality metrics and network data. The machine learning model may be trained and retrained based on the xAPP 144 receiving real-time time series data. The real-time update in time series data helps to strengthen the predictions made by the xAPP, and increases the overall performance of the system.

The O-DU 126 and the O-CU 128 are configured to generate (e.g., prepare) data for transmission using the O-RAN, where the O-DU 126 is configured to prepare data for lower layer protocols and the O-CU 128 is configured to prepare data for higher layer protocols. For example, the O-DU 126 can structure data or information of physical layer protocols for the RIC 114 to provide to one or more other computing devices in the O-RAN.

The SMO engine 122 can provide policy information 150 to the near-real-time RIC 124 for performing one or more traffic control or traffic analysis operations during the communication session. The policy information 150 can include data from the RAN analytics 132 including network data, performance metrics, user data, or outputs of the models 130 generated from data of the RAN analytics 132. Based on the policy information 150, the near-real-time RIC 124 can perform RAN control 140 or RAN optimization 142, and, in some examples, the near-real-time RIC 124 can execute the xApps 144 based on the policy information 150. The near-real-time RIC 124 is configured to provide control information 152 to the O-DU 126, the O-CU 128, or both to communicate with one or more other devices of the O-RAN network. For example, the near-real-time RIC 124 can provide control information 124 including RAN optimization information 142 or outputs from execution of xApps 144 to a user device of the O-RAN network.

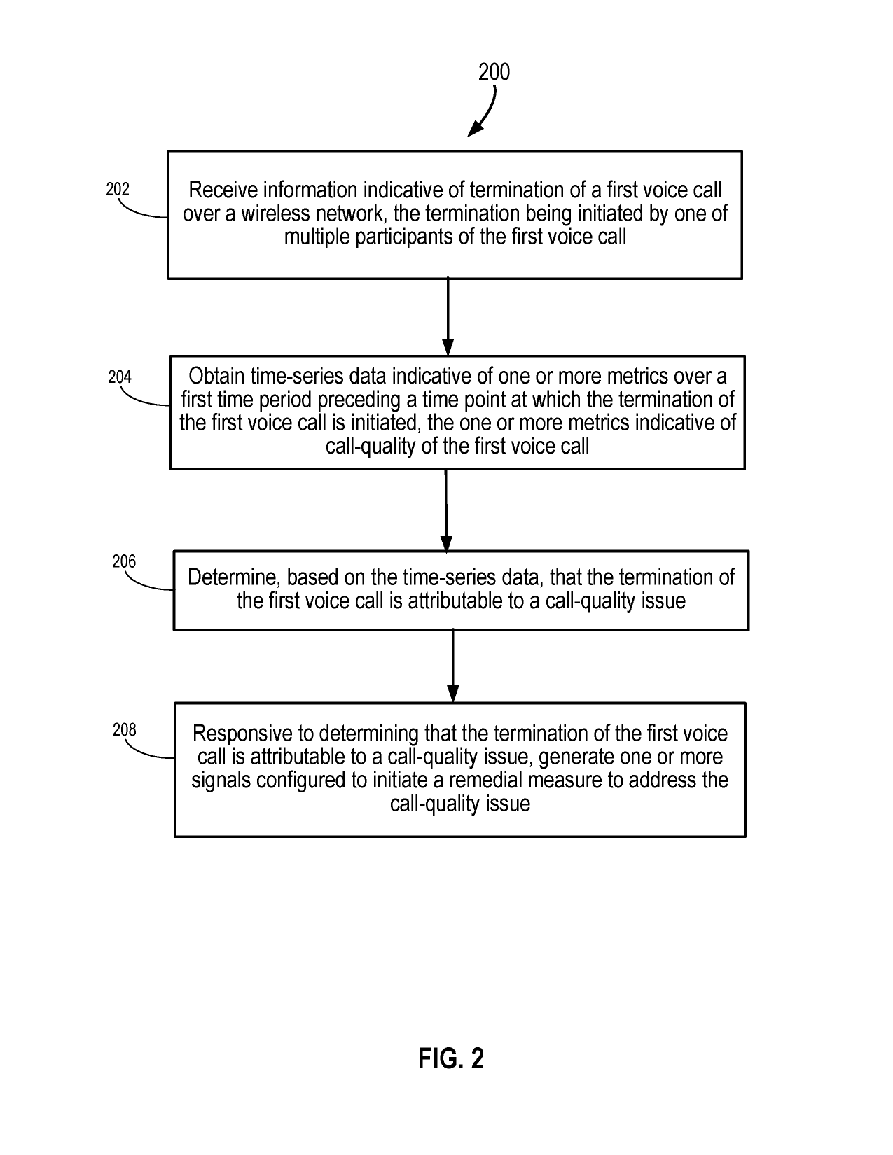

FIG. 2 illustrates exemplary process 200 for generating one or more signals configured to initiate a remedial measure to address a call quality issue. The following describes the process 200 as being performed by components of the system 100 described above with reference to FIGS. 1A and 1B. For example, the cloud system 106 or the the xAPP 144 of the RIC 114. However, the process 200 may be performed by other systems and configurations. Briefly, the process 200 may include receiving, at one or more processing devices, information indicative of termination of a first voice call over a wireless network, the termination being initiated by one of multiple participants of the first voice call (202), and obtaining, by the one or more processing devices, time series data indicative of one or more metrics over a first time period preceding a time point at which the termination of the first voice call is initiated, the one or more metrics indicative of call quality of the first voice call (204). The process may further include determining, based on the time series data, that the termination of the first voice call is attributable to a call quality issue (206), and responsive to determining that the termination of the first voice call is attributable to a call-quality issue, generating one or more signals configured to initiate a remedial measure to address the call-quality issue (208).

In more detail, process 200 may include receiving, at one or more processing devices, information indicative of termination of a first voice call over a wireless network, the termination being initiated by one of multiple participants of the first voice call (202). For example, this may correspond to at least one network component within the network 101 receiving a termination signal from a UE 104. The at least one component within the network 101 may receive the termination signal from a UE 104, process the signal, and subsequently confirm that the call was terminated. For example, a base station 102 within the network 101 may determine that the call was intentionally terminated by one of the participants of the call when the base station received the termination signal from the UE 104.

The one or more components of the network 101 may be configured to differentiate between a dropped call, i.e., a call where the connection is unexpectedly lost, versus a call that is intentionally terminated by a participant of the call. The one or more base stations 102 within the network 101 may monitor the quality of the connections with a UE 104, and may detect when the signal quality of the connection with a particular UE 104 is below a threshold and/or degrades over time. The UE 104 simultaneously measures the signal strength and signal connection to the cell tower that is closest to the location of the UE 104. In some implementations, the UE 104 may utilize periodic “keep alive” messages to verify whether the connection is still active, and a call may be considered as dropped if the network 101 does not receive a “keep alive” message from a UE within a specific timeframe of another “keep alive” message. On the other hand, the network 101 may determine that a call was intentionally terminated when a base station 102 within the network 101 receives a termination signal from the UE 104 of one of the participants of the call.

The process 200 may include obtaining, by the one or more processing devices, time series data indicative of one or more metrics over a first time period preceding a time point at which the termination of the first voice call is initiated, the one or more metrics indicative of call quality of the first voice call (204). For example, this may correspond to at least component of the network 101 obtaining data that indicates an audio gap that exceeds a threshold period of time. In some implementations, the first time period preceding the time point at which the termination of the call is initiated may be a set time period. For example, the time period may be ten seconds preceding the termination of the call.

In other implementations, the time period may be determined dynamically based on the total length of the call and one or more other factors. In some implementations, the time period may be based on a percentage of the total length of time of the call. For example, the time period may be the last 10% of the total call time, or the last 20% of the total call time. As described above, with reference to FIG. 1A, the time series data may include one or more of the following types of data: mean opinion score data, audio gap data, packet loss rate data, Real-time Transport Protocol (RTP) jitter value data, signal-to-interference-plus-noise ratio (SINR) data, a reference signal received power (RSRP) data, transmission control protocol (TCP) transmission rate data, block error rate (BLER) data, bit error rate (BER) data, and/ or uplink received signal strength indicator (RSSI) data.

The process 200 may include determining, based on the time series data, that the termination of the first voice call is attributable to a call quality issue (206). For example, this may correspond to the one or more processing devices at the cloud system 106 of the network 101 determining that the time series data indicates a degradation of call quality during the period before the call was termination, and a base station 102 receiving data indicating that a participant of the call initiated a subsequent call. In some implementations, the cloud system 106 may be configured to determine that the termination of the call was attributable to the call quality issue based on a base station 102 receiving data indicating that a participant of an initial call attempted a subsequent call within a threshold time period after the initial call was terminated. For example, when the base station 102 receives data indicating that a participant of the initial call initiated a subsequent call within ten seconds of the termination of the initial call. In some implementations, the cloud system 106 may determine that the termination of the call was based on call quality whenever a participant of the initial call attempts to initiate a subsequent call within one minute of the termination of the initial call. In another implementation, the cloud system 106 makes the determination only when an attempt to initiate a call (after the termination of the initial call) is paired with a degradation of the call quality.

In some implementations, the cloud system 106 may utilize a machine learning model, which is trained to identify whether a call quality issue was the cause for a user 108 terminating a call, to identify when the termination of the call is due to a call quality issue. The trained machine learning model can be trained and retrained based on the cloud system 106 receiving time series data, which is indicative of one or more metrics indicative of call quality, over time. For example, a machine learning model can be trained via a supervised learning process using a large corpus of call quality metrics and network data. In some implementations the machine learning model can be trained and retrained on a periodic basis. The machine learning model may be trained based on call quality metrics and network data associated with the network 101. In some implementations, the machine learning model may be trained on network performance data received form a plurality of different networks. For example, the cloud application server 106 may receive call quality metrics and network data from a roaming partner’s network.

The process 200 may include responsive to determining that the termination of the first voice call is attributable to a call quality issue, generating one or more signals configured to initiate a remedial measure to address the call-quality issue (208). For example, this may correspond to the one or more processing devices at the cloud system 106 transmitting a signal to instruct a user equipment application on a UE 104 to cause the UE 104 to connect to a second network that is available in the user’s location. In some implementations, the second network may be a wireless network that is managed and maintained by a second wireless service provider. In these implementations, the second network may be considered a roaming network. In other implementations, the second network may be a wireless network that is managed by the same entity.

In some implementations, the one or more processing devices at the cloud system 106 may transmit a signal to instruct one or more components within the network 101 to implement a change in the distribution of resources within the network 101 to mitigate the call degradation. For example, the cloud system 106 may transmit a signal to instruct the network to offload one or more users that have a high usage of the impacted channel resource. In some implementations, when the cloud system 106 determines that the call quality issue is due to the location of the user 108, the cloud system 106 may accelerate idle mode reselection for the UE. In some implementations, the cloud system may accelerate the connected mode mobility to focus on offloading users 108 with reported time advance greater than a threshold value.

In some implementations, the xAPP is configured to receive the time series data, and use the received time series data to train a machine learning model that is configured to predict voice call quality degradation. In these implementations, the xAPP may be configured to implement network parameter configuration changes which can help to prevent or mitigate future voice call quality degradation. The network parameter configuration changes may involve triggering accelerated idle mode reselection to offload UEs to less loaded impacted layers. In some implementations, the xAPP is configured to change network parameter configuration by dedicating idle or connected mobility configuration to offload uses to less impacted technologies. For example, when the xAPP determines that a user 108 experienced a voice call degradation, the xAPP may be configured to accelerate idle mode reselection for the UE experiencing the voice call degradation.

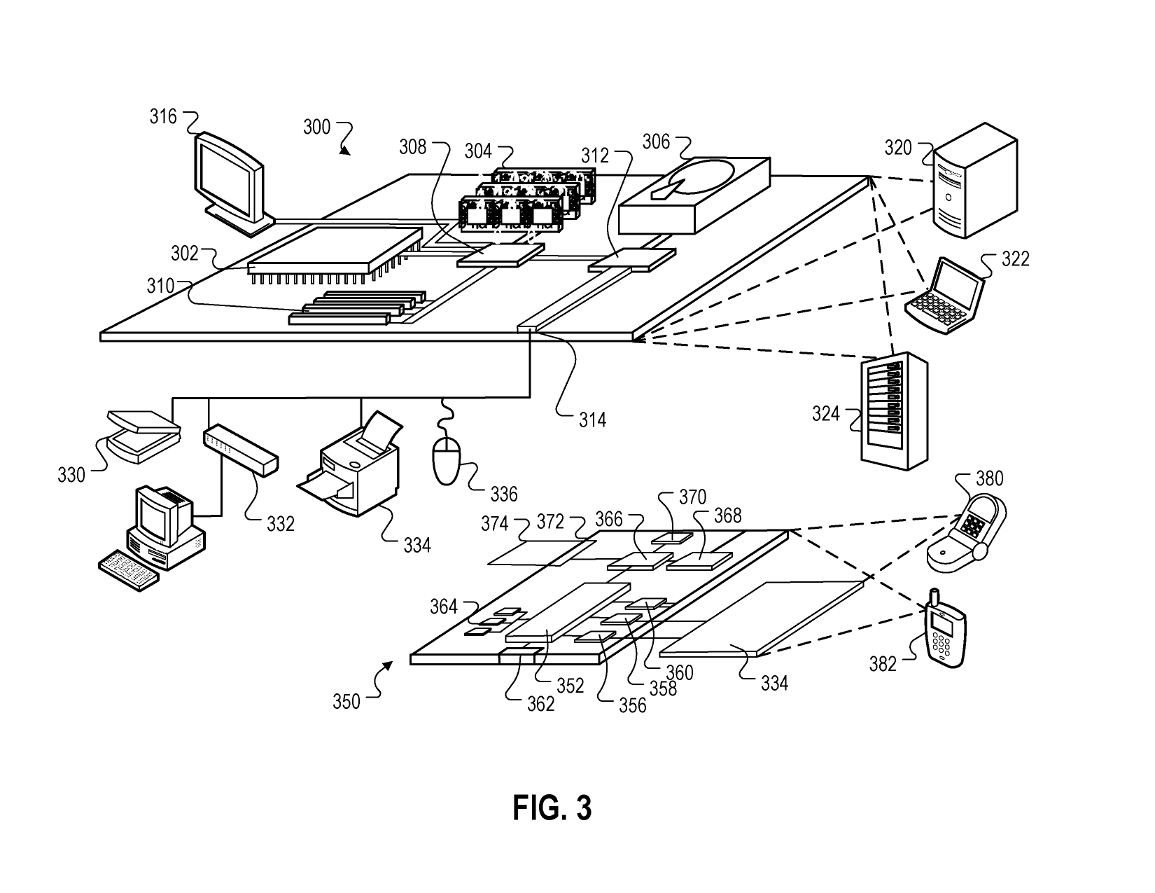

FIG. 3 shows an example of a computing device 300 and a mobile computing device 350 that can be employed to execute implementations of the present disclosure. For example, the RAN entities described above can be part of a 5G Open RAN (O-RAN) architecture deployed in a cloud computing environment, and computing devices 300 (and/or mobile devices 350) may be used to implement various portions of such a cloud computing environment.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 300 and/or the mobile computing device 350 can be user devices that form at least a portion of a system that runs one or more software applications to implement the technology described herein. The computing device 300 and/or the mobile computing device 350 can also be used to perform at least a portion of the process 200 described in relation to FIG. 2.

The computing device 300 includes a processor 302, a memory 305, a storage device 306, a high-speed interface 308, and a low-speed interface 312. In some implementations, the high-speed interface 308 connects to the memory 304 and multiple high-speed expansion ports 310. In some implementations, the low-speed interface 312 connects to a low-speed expansion port 314 and the storage device 304. Each of the processor 302, the memory 304, the storage device 306, the high-speed interface 308, the high-speed expansion ports 310, and the low-speed interface 312, are interconnected using various buses, and may be mounted on a common motherboard or in other manners as appropriate. The processor 302 can process instructions for execution within the computing device 300, including instructions stored in the memory 304 and/or on the storage device 306 to display graphical information for a graphical user interface (GUI) on an external input/output device, such as a display 316 coupled to the high-speed interface 308. In other implementations, multiple processors and/or multiple buses may be used, as appropriate, along with multiple memories and types of memory.

The memory 304 stores information within the computing device 300. In some implementations, the memory 304 is a volatile memory unit or units. In some implementations, the memory 304 is a non-volatile memory unit or units. The memory 304 may also be another form of a computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 302, perform one or more methods, such as those described above. The instructions can also be stored by one or more storage devices, such as computer-readable or machine-readable mediums, such as the memory 304, the storage device 306, or memory on the processor 302.

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards. In the implementation, the low-speed interface 312 is coupled to the storage device 303 and the low-speed expansion port 314. The low-speed expansion port 314, which may include various communication ports (e.g., Universal Serial Bus (USB), Bluetooth, Ethernet, wireless Ethernet) may be coupled to one or more input/output devices. The input/output devices may also be coupled to the low-speed expansion port 314 through a network adapter. Such network input/output devices may include, for example, a switch or router.

The computing device 300 may be implemented in a number of different forms, as shown in FIG. 3. For example, it may be implemented as a standard server 320, or multiple times in a group of such servers. In addition, it may be implemented in a personal computer such as a laptop computer 322. It may also be implemented as part of a rack server system 324.

In some implementations, components from the computing device 300 may be combined with other components in a mobile device, such as a mobile computing device 350. Each of such devices may contain one or more of the computing device 300 and the mobile computing device 350, and an entire system may be made up of multiple computing devices communicating with each other.

The mobile computing device 350 includes a processor 352; a memory 334; an input/output device, such as a display 354; a communication interface 333; and a transceiver 338; among other components. The mobile computing device 350 may also be provided with a storage device, such as a micro-drive or other device, to provide additional storage. Each of the processor 352, the memory 334, the display 355, the communication interface 333, and the transceiver 338, are interconnected using various buses, and several of the components may be mounted on a common motherboard or in other manners as appropriate.

The processor 352 may communicate with a user through a control interface 358 and a display interface 353 coupled to the display 354. The display 354 may be, for example, a Thin-Film-Transistor Liquid Crystal Display (TFT) display, an Organic Light Emitting Diode (OLED) display, or other appropriate display technology. The display interface 353 may include appropriate circuitry for driving the display 354 to present graphical and other information to a user. The control interface 358 may receive commands from a user and convert them for submission to the processor 352. In addition, an external interface 332 may provide communication with the processor 352, so as to enable near area communication of the mobile computing device 350 with other devices. The external interface 332 may provide, for example, for wired communication in some implementations, or for wireless communication in other implementations, and multiple interfaces may also be used.

The memory 334 stores information within the mobile computing device 350. The memory 334 can be implemented as one or more of a computer-readable medium or media, a volatile memory unit or units, or a non-volatile memory unit or units. An expansion memory 374 may also be provided and connected to the mobile computing device 350 through an expansion interface 372. The expansion memory 374 may provide extra storage space for the mobile computing device 350, or may also store applications or other information for the mobile computing device 350. Specifically, the expansion memory 374 may include instructions to carry out or supplement the processes described above, and may include secure information also.

The memory may include, for example, flash memory and/or non-volatile random access memory (NVRAM), as discussed below. In some implementations, instructions are stored in an information carrier. The instructions, when executed by one or more processing devices, such as processor 352, perform one or more methods, such as those described above. The instructions can also be stored by one or more storage devices, such as one or more computer-readable or machine-readable mediums, such as the memory 334, the expansion memory 374, or memory on the processor 352. In some implementations, the instructions can be received in a propagated signal, such as, over the transceiver 338 or the external interface 332.

The mobile computing device 350 may communicate wirelessly through the communication interface 333, which may include digital signal processing circuitry where necessary. The communication interface 333 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 338 using a radio frequency. In addition, short-range communication, such as using a Bluetooth or Wi-Fi, may occur. In addition, a Global Positioning System (GPS) receiver module 370 may provide additional navigation and location-related wireless data to the mobile computing device 350, which may be used as appropriate by applications running on the mobile computing device 350.

The mobile computing device 350 may also communicate audibly using an audio codec 330, which may receive spoken information from a user and convert it to usable digital information. The audio codec 330 may likewise generate audible sound for a user, such as through a speaker, e.g., in a handset of the mobile computing device 350.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

This specification uses the term “configured to” in connection with systems, apparatus, and computer program components. That a system of one or more computers is configured to perform particular operations or actions means that the system has installed on software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claim may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, at one or more processing devices, information indicative of termination of a first voice call over a wireless network, the termination being initiated by one of multiple participants of the first voice call;
obtaining, by the one or more processing devices, time series data indicative of one or more metrics over a first time period preceding a time point at which the termination of the first voice call is initiated, the one or more metrics indicative of call quality of the first voice call;
determining, based on the time series data, that the termination of the first voice call is attributable to a call quality issue; and
responsive to determining that the termination of the first voice call is attributable to a call-quality issue, generating one or more signals configured to initiate a remedial measure to address the call quality issue.

2. The method of claim 1, wherein determining that the termination of the first voice call is attributable to a call quality issue further comprises:
obtaining, by the one or more processing devices, information indicative of an attempt by one of the multiple participants to initiate a second voice call with another of the multiple participants; and
determining that the time series data indicates a degradation of the call quality during the first time period.

3. The method of claim 1, wherein determining that the termination of the first voice call is attributable to a call-quality issue further comprises:
providing the time series data to a machine learning model trained to identify a cause for call termination based on the one or more metrics; and
determining, based on an output of the machine learning model, that the termination of the first voice call is attributable to a call quality issue.

4. The method of claim 1, wherein the one or more metrics indicative of call quality of the first voice call comprises information indicative of an audio gap detected during the first voice call exceeding a threshold period of time.

5. The method of claim 1, wherein the one or more metrics indicative of call quality of the first voice call comprises information indicative of a quantified quality score being less than a threshold value during the first voice call.

6. The method of claim 1, wherein the one or more metrics indicative of call quality of the first voice call comprises information indicative of a packet loss rate and a jitter value.

7. The method of claim 1, wherein the one or more metrics indicative of call quality of the first voice call comprises information indicative of at least one of: a signal-to-interference-plus-noise ratio (SINR) or a reference signal received power (RSRP).

8. The method of claim 1, wherein the one or more metrics indicative of call quality of the first voice call comprises information indicative of at least one of: a block error rate (BLER) or a bit error rate (BER).

9. The method of claim 1, wherein generating the one or more signals configured to initiate the remedial measure to address the call-quality issue comprises generating a signal to instruct a user device identified as experiencing a call quality issue to switch to an available roaming network.

10. The method of claim 1, wherein generating the one or more signals configured to initiate the remedial measure to address the call-quality issue comprises generating a signal to instruct one or more user equipment to accelerate idle mode resection.

11. The method of claim 1, wherein generating the one or more signals configured to initiate the remedial measure to address the call-quality issue comprises generating a signal to offload user equipment that have a signal quality below a threshold quality value.

12. A system comprising:
one or more computers and one or more storage devices on which are stored instructions that are operable, when executed by the one or more computers, to cause the one or more computers to perform operations comprising:
receiving, at one or more processing devices, information indicative of termination of a first voice call over a wireless network, the termination being initiated by one of multiple participants of the first voice call;
obtaining, by the one or more processing devices, time series data indicative of one or more metrics over a first time period preceding a time point at which the termination of the first voice call is initiated, the one or more metrics indicative of call quality of the first voice call;
determining, based on the time series data, that the termination of the first voice call is attributable to a call quality issue; and
responsive to determining that the termination of the first voice call is attributable to a call-quality issue, generating one or more signals configured to initiate a remedial measure to address the call quality issue.

13. The system of claim 12, wherein determining that the termination of the first voice call is attributable to a call quality issue further comprises:
obtaining, by the one or more processing devices, information indicative of an attempt by one of the multiple participants to initiate a second voice call with another of the multiple participants; and
determining that the time series data indicates a degradation of the call quality during the first time period.

14. The system of claim 12, wherein determining that the termination of the first voice call is attributable to a call-quality issue further comprises:
providing the time series data to a machine learning model trained to identify a cause for call termination based on the one or more metrics; and
determining, based on an output of the machine learning model, that the termination of the first voice call is attributable to a call quality issue.

15. The system of claim 12, wherein the one or more metrics indicative of call quality of the first voice call comprises information indicative of an audio gap detected during the first voice call exceeding a threshold period of time.

16. The system of claims claim 12, wherein the one or more metrics indicative of call quality of the first voice call comprises information indicative of a quantified quality score being less than a threshold value during the first voice call.

17. The system of claim 12, wherein the one or more metrics indicative of call quality of the first voice call comprises information indicative of a packet loss rate and a jitter value.

18. The system of claim 12, wherein the one or more metrics indicative of call quality of the first voice call comprises information indicative of at least one of: a signal-to-interference-plus-noise ratio (SINR) or a reference signal received power (RSRP).

19. The system of claim 12, wherein the one or more metrics indicative of call quality of the first voice call comprises information indicative of at least one of: a block error rate (BLER) or a bit error rate (BER).

20. One or more non-transitory computer storage media encoded with computer program instructions that when executed by one or more computers cause the one or more computers to perform operations comprising:
receiving, at one or more processing devices, information indicative of termination of a first voice call over a wireless network, the termination being initiated by one of multiple participants of the first voice call;
obtaining, by the one or more processing devices, time series data indicative of one or more metrics over a first time period preceding a time point at which the termination of the first voice call is initiated, the one or more metrics indicative of call quality of the first voice call;
determining, based on the time series data, that the termination of the first voice call is attributable to a call quality issue; and
responsive to determining that the termination of the first voice call is attributable to a call-quality issue, generating one or more signals configured to initiate a remedial measure to address the call quality issue.
